(19) United States
(12) Patent Application Publication
(10) Pub. No.: US 2009/0121059 A1
(43) Pub. Date: May 14, 2009

(54) Device and Method to Disintegrate Fat in the Human Body

(76) Inventor: Manuel Jesus Rios Garcia, Zapopan (MX)

Correspondence Address: BELASCO, JACOBS & TOWNSLEY LLP;HOWARD HUGHES CENTER, 6701 CENTER DRIVE, 14th Floor, LOS ANGELES, CA, 90045, US

(21) Appl. No.: 11/720,500

(22) PCT Filed: Dec. 17, 2004
(86) PCT No.: PCT/MX04/00096

§ 371 Date: May 30, 2007

(51) Int. Cl. B02C 17/02

(52) U.S. Cl. 241/92

(57) ABSTRACT

This invention is best described as a human body fat disintegrator device which is conformed by a semi-rectangular frame with a handle on one end and a grip on the other, as well as a series of round profile teeth, located perpendicularly, and alternately, across the frame's upper face, and a series of sharp profile teeth located at the frame's lower face. The description of this invention also outlines a method for eliminating fat from the human body, consisting of holding the above described human body fat disintegrator device by the handle and grip; then positioning either of the device's toothed surface over the designated area, applying such pressure as not to harm the user; and sliding or dragging the device over the designated area with a backward and forward motion on the device's longitudinal direction for 10 to 15 seconds, alternating massage on different parts of the body, as required.

### CROSS REFERENCE TO RELATED APPLICATION

Applicant claims priority to his PCT application, Ser. No. PCT/MX2004/000096, filed 17 Dec. 2004.

### BACKGROUND OF THE INVENTION

(1) Field of the Invention

Herein described invention will have respective field of application in physical personal maintenance (aesthetics) area, specifically to eliminate excessive accumulated fat in the human body and consequently size reduction.

(2) Description of the Related Art

My fondness for practicing sports and my intention to eliminate undesired fat in certain parts of my body guided me for many years to analyze different methods of eliminating fat.

Today, there are different kinds of devices, products and treatments which claim to be useful to eliminate body fat, nevertheless, from my own point of view, all of them display different inconveniences such as those as I herein describe:

Most of the manual body fat elimination devices have different parts which, in some cases, are mobile and require a certain degree of care or maintenance in order for them to work properly. There are others which are big and bulky and therefore require ample space, both for its usage, as well as for its storage. The great variety of materials from which these devices are made also result in different inconveniences, such as parts becoming loose and lost or others that wear down, including metal parts which rust when wet. On the other hand, there are also many devices which require electric power to work and therefore cannot be used in direct contact with water. Included in this area are also gel based products as well as reduction creams which, as the other options, result in certain reactions such as skin allergies or even restrictions to use them only at certain specific hours or having to wear protective gear, not exposing the product to certain weather conditions, etc.

In addition, there are also other methods, such as surgical procedures, with liposuction being the most popular. This method is not practical because it is expensive and if not performed by an experienced professional may result in serious physical consequences.

Development of a simple device which can break down body fat represents a great improvement in the field of athletics and satisfies a long felt need of the athlete.

### SUMMARY OF THE INVENTION

Gradually, through trial and error, using different products and experiencing first hand inadequacies or technical deficiencies, that after multiple studies and tests, I developed tins human body fat disintegrator device. My device comprises: a semi-rectangular frame having an upper face, a lower face and two ends; a plurality of round profile teeth, located perpendicularly and alternately across the upper face; and a plurality of sharp profile teeth, located perpendicularly and alternately on the lower face.

The device can have a shape in which the upper face is concave and the lower face is convex. Alternately the device can have three, four or more surfaces with teeth, round or sharp, along each surface. In this case the surfaces would form a triangular, rectangular, etc. cross-sectional shape. The device preferably has a handle at one end and a grip at the other end holding and maneuvering it.

The device is used by: holding the device by the handle and grip; positioning some of the round profile or sharp profile teeth over a desired area of a human body; applying sufficient pressure to disintegrate fat without harm to the body; and sliding the device backwards and forwards over the desired area for 10 to 15 seconds.

The human body fat disintegrator device does not require electric power nor does it need to be assembled in order to work. It does not have mobile parts which may become loose or lost; it is made of a single piece of the same material. It does not bend, fold, inflate, deflate, rust, or require any maintenance or special care. The device does not need other products to be used (such as gel, creams etc.), or require any special techniques. In addition, due to its design and it's availability in small, medium and large sizes, it may be carried anywhere and used practically under any condition or circumstance, wearing clothes or without, in the shower, the pool, home or gymnasium, without the need to hydrate or submit the body to mineral salts elimination. It is important to mention that the most important feature of this device, when compared to the others, is its higher adipose tissue (fat) disintegration effectiveness without expending physical effort or taking related risks. This device guarantees results with 2 to 4 minutes of daily use for two weeks.

An appreciation of the other aims and objectives of the present invention and an understanding of it may be achieved by referring to the accompanying drawings and description of a preferred embodiment.

### BRIEF DESCRIPTION OF THE DRAWINGS

The human body fat disintegrator device is herein described and said description is supported by the following figures:

FIG. 1 is a human body fat disintegrator device perspective view.

FIG. 2 is a human body fat disintegrator device upper view.

FIG. 3 is a human body fat disintegrator device lower view

FIG. 4 is a device, minus teeth, perspective view.

FIG. 5 is a round profile tooth perspective view.

FIG. 6 is a sharp profile tooth perspective view

FIG. 7 is one of the invention's modalities perspective view.

FIG. 8 is a human body fat disintegrator device's modality upper view, as per FIG. 7.

FIG. 9 is a human body rat disintegrator device's modality lower view, as per FIG. 7.

FIG. 10 is an upper view of the device working, with arrows indicating the device's movement.

FIG. 11 illustrates an embodiment of this invention having a rectangular cross section with different shaped teeth on each side.

FIG. 12 illustrates an embodiment of this invention having a circular cross section with different shaped teeth on each side.

FIG. 13 illustrates an embodiment of this invention having a triangular cross section with different shaped teeth on each side.

FIG. 14 illustrates an embodiment of this invention having an oval cross section with different shaped teeth on each side.

FIG. 15 illustrates an embodiment of this invention having a chevron shaped cross section several different kinds of teeth.

FIG. 16 illustrates an embodiment of this invention having a concave/convex cross section and several different kinds of teeth.

FIGS. 17-22 illustrate various different shaped teeth that can be used on this invention.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

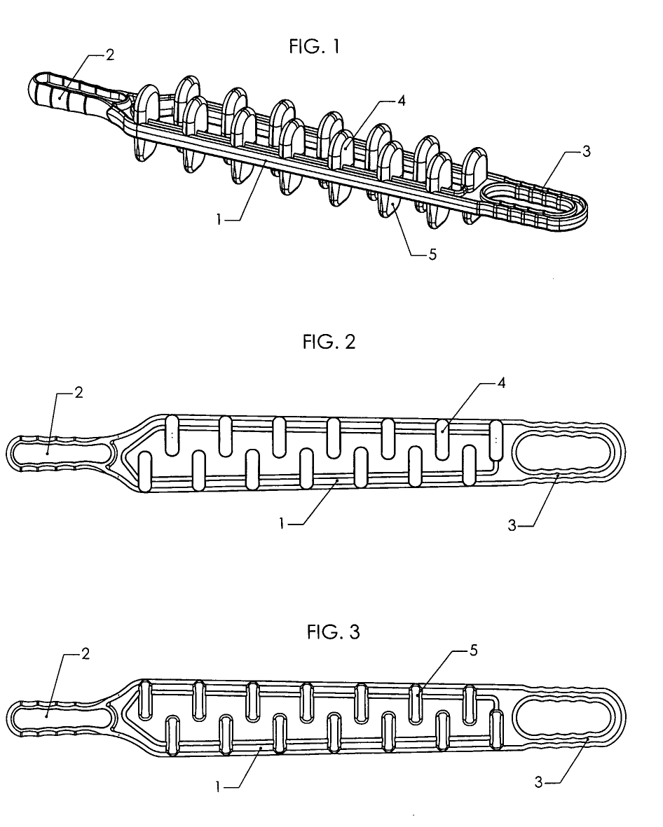

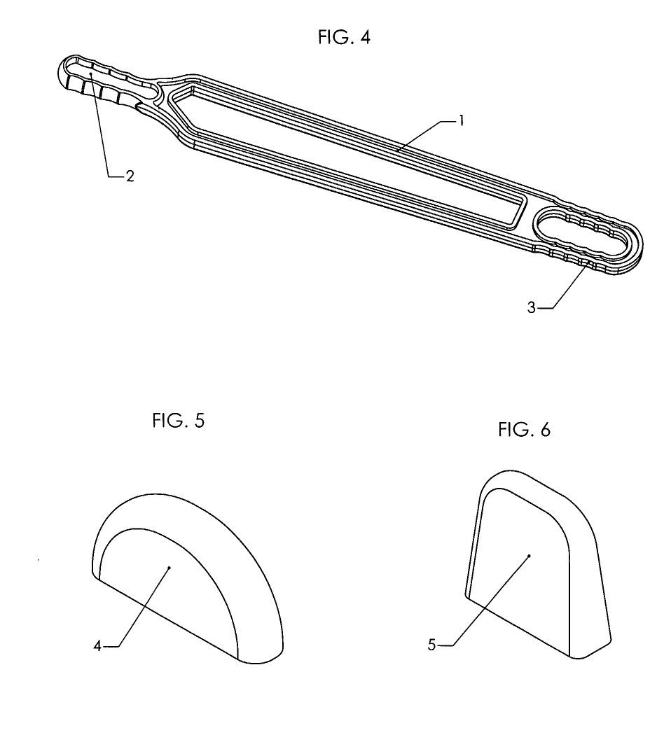

According to the aforementioned figures, the human body fat disintegrator device is basically conformed into a semi-rectangular frame 1 which on one of its ends incorporates a handle 2 and on the other end, a grip 3, which are used to hold and maneuver the device. Along the aforementioned frame's 1 upper face, distributed in perpendicular and alternate fashion are a series of round profile teeth 4 and in the lower face distributed, in the same manner, are a series of sharp profile teeth 5 as shown in FIG. 1; said teeth 4 and 5 serve to break down and disintegrate adipose tissue in the human body.

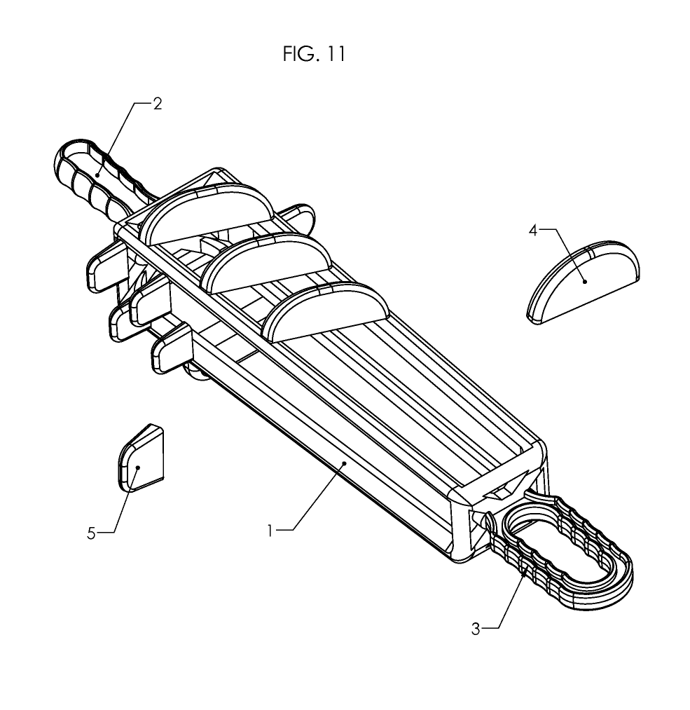

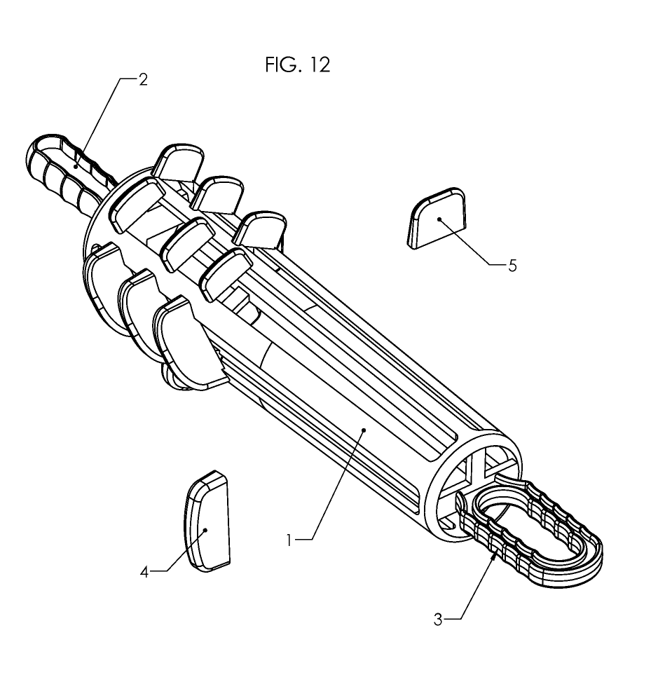

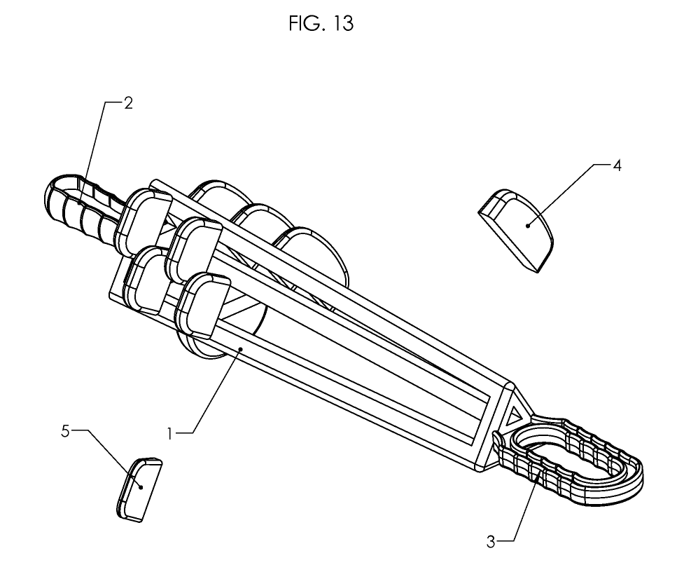

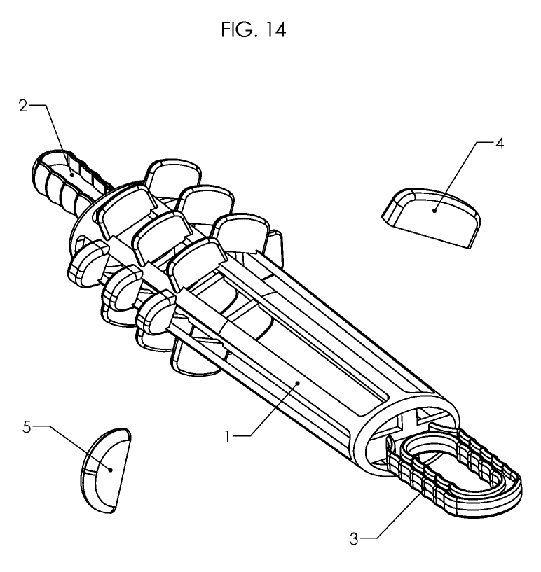

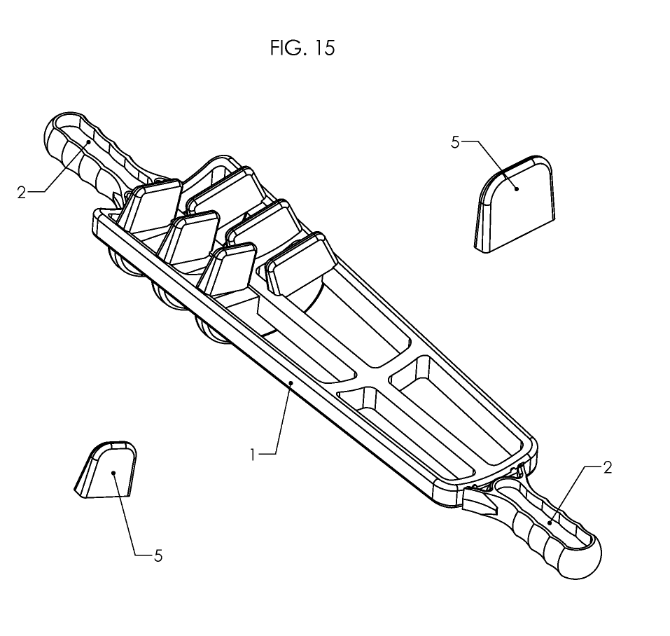

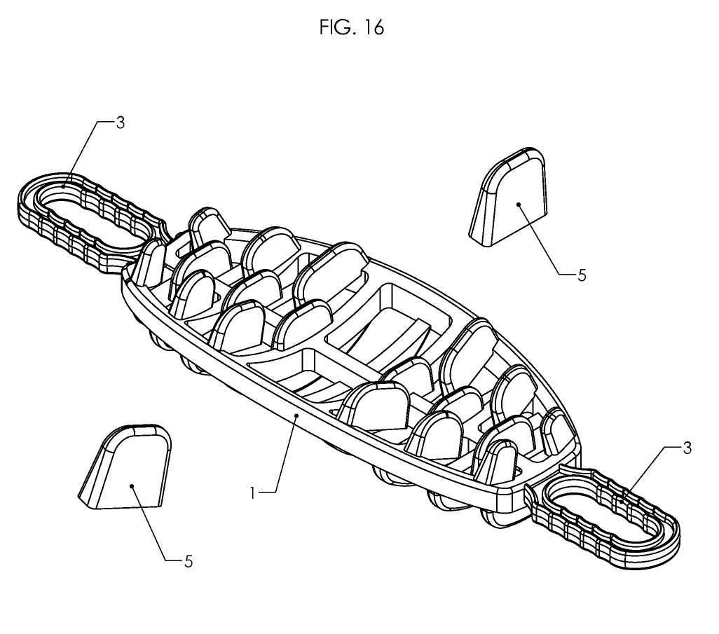

According to the device's different modalities, the frame 1 can, in fact, be adapted to different geometrical shapes, such as square, round, triangular, oval, etc. (see FIGS. 11-16); and may also incorporate on its ends a handle 2, a grip 3 or a combination thereof.

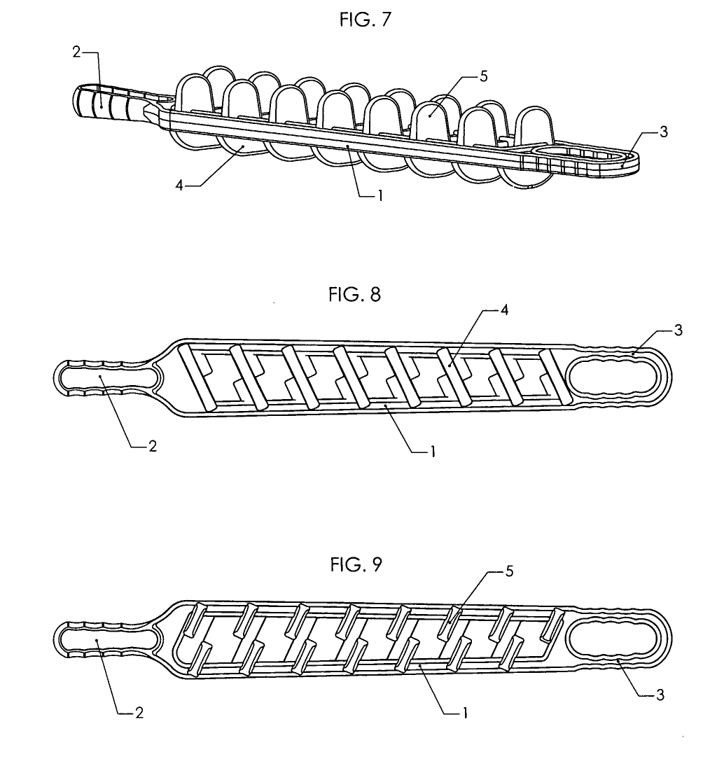

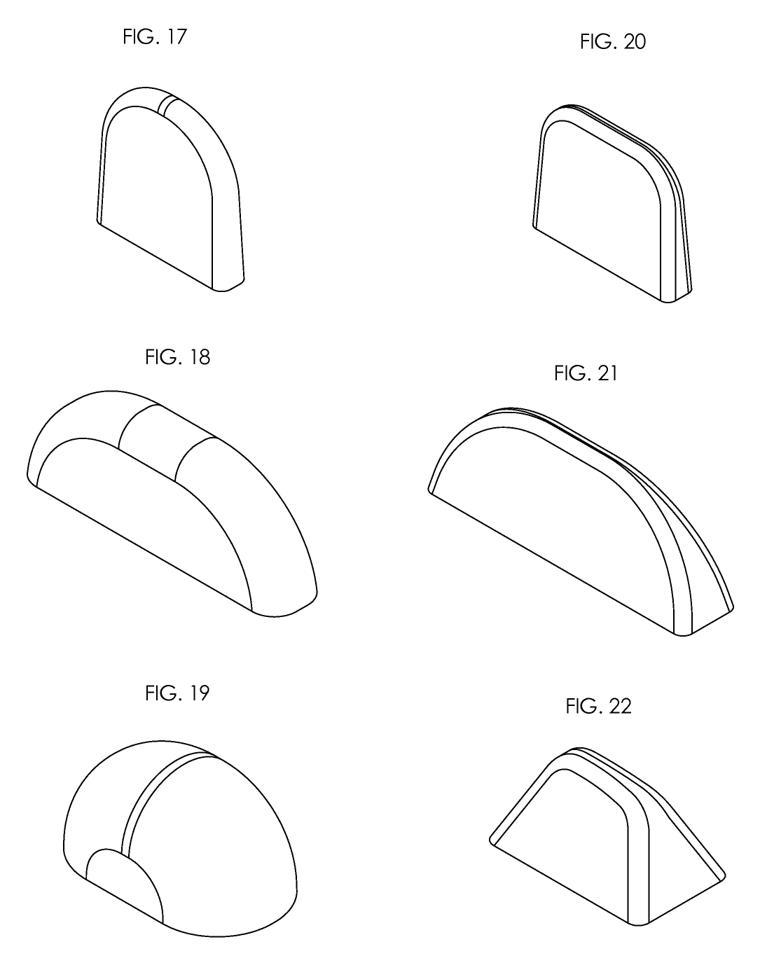

Another variation of this device is that its teeth 4 and 5 may be positioned at different angles with respect to the frame 1, including varying the sizes of spaces between them, as well as the width, height and thickness of the teeth. See FIG. 7. In addition, the teeth may have almost any conceivable shape; a variety is illustrated on FIGS. 17-22.

The human body fat disintegrator device's physical structures, as well as respective components, were designed in order for its production to occur by way of plastic injection molds, therefore simply manufactured and a low cost product. Nevertheless, these features do not restrict the device from being manufactured by other methods or with other types of materials.

The human body fat disintegrator device is used by applying the following method:

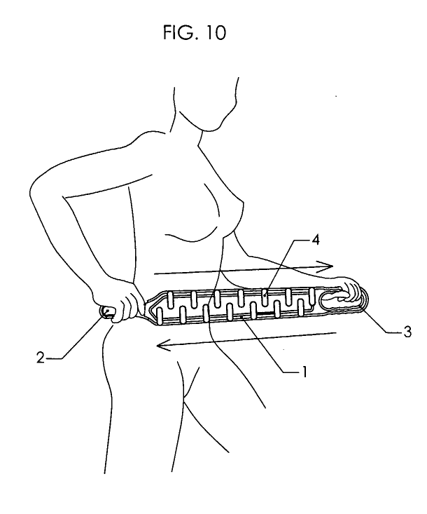

Handle 2 is taken with one hand and grip 3 with the other, and teeth 4 or 5 are positioned over the designated area applying such pressure as not to harm the user, sliding or dragging the device with a backward and forward motion on the device's longitudinal direction for short periods of time, alternating massage on different parts of the body, as required, see FIG. 10.

Moreover, this patent application also claims a method to eliminate fat from human the body, according to the following stages:

a) Holding above described human body fat disintegrator device by the handle 2 and grip 3.

b) Positioning any of the devices's toothed surface over the designated area applying such pressure as not to harm the user.

c) Sliding or dragging the device over the designated area with a backward and forward motion on the device's longitudinal direction, for a duration of 10 to 15 seconds, alternating massage on different parts of the body, as required.

Herein described human body fat disintegrator device surpasses existing devices from a technical point of view, since the device features the following advantages:

a) Re-shapes the body's contour based on frequent and continuous breaking down of fat cells in those areas with the highest adipose tissue accumulation, achieving a more aesthetic body shape.

b) Helps break-down accumulated, fat cells (adipose tissue) in order that they can be re-absorbed by the body and be used as energy.

c) Activates blood circulation in the manipulated area, stimulates the distribution of nutriments

d) stimulates the distribution of nutriments and promotes the elimination of toxins by blood

e) Activates soporiferous glands, eliminating impurities through perspiration.

f) Stimulates lymphatic circulation

g) Daily usage of both the human body fat disintegrator device and using the aforementioned method, will automatically and aerobically strengthen the muscles of abdomen, waist, aims, shoulders, chest, and back.

Thus, the present invention has been described herein with reference to a particular embodiment for a particular application. Those having ordinary skill in the art and access to the present teachings will recognize additional modifications, applications and embodiments within the scope thereof.

Upon having sufficiently and clearly described my invention, I consider it a novelty and therefore I claim, as my exclusive property, the contents as expressed in the following claims. It is therefore intended by the appended claims to cover any and all such applications, modifications and embodiments within the scope of the present invention.

What is claimed is:

1. A human body fat disintegrator device comprising:
i) a semi-rectangular frame having an upper face, a lower face and two ends;
ii) a plurality of round profile teeth, located perpendicularly and alternately across said upper face; and
iii) a plurality of sharp profile teeth located perpendicularly and alternately on said lower face.

2. A device as claimed in claim 1 further comprising a handle at one of said ends for holding and maneuvering said device.

3. A device as claimed in claim 1 further comprising a grip at one of said ends for holding and maneuvering said device.

4. A device as claimed in claim 1 in which said upper face is concave and said lower face is convex.

5. A human body fat disintegrator device comprising:
i) a semi-rectangular frame having at least three surfaces and two ends;
ii) a plurality of round profile teeth, located perpendicularly and alternately across one of said surfaces; and
iii) a plurality of sharp profile teeth, located perpendicularly and alternately on another of said surfaces.

6. A device as claimed in claim 5 further comprising a handle at one of said ends for holding and maneuvering said device.

7. A device as claimed in claim 5 further comprising a grip at one of said ends for holding and maneuvering said device.

8. A method of disintegrating human body fat comprising the steps of;
i) providing a device comprising, in combination;
i. a semi-rectangular frame having at least two surfaces and two ends;
ii. a plurality of round profile teeth, located perpendicularly and alternately across one of said surfaces;
iii. a plurality of sharp profile teeth, located perpendicularly and alternately on another of said surfaces;
iv. a handle at one of said ends for holding and maneuvering said device; and
v. a grip at the other end for holding and maneuvering said device;
ii) holding said device by the handle and grip;
iii) positioning one of said plurality of round profile teeth or said plurality of sharp profile teeth over a desired area of a human body;
iv) applying sufficient pressure to disintegrate fat without harm to the body; and
v) sliding said device backwards and forwards over said desired area for 10 to 15 seconds.
